(19) United States
(12) Patent Application Publication
(10) Pub. No.: US 2008/0187166 A1
(43) Pub. Date: Aug. 7, 2008

(54) Loudspeaker system

(75) Inventor: Tien-I Ko, Taipei 104 (TW)

Correspondence Address: BACON & THOMAS, PLLC, 625 SLATERS LANE, FOURTH FLOOR, ALEXANDRIA, VA, 22314, US

(73) Assignee: OXIWIN TECHNOLOGY, INC., Taipei 104 (TW)

(21) Appl. No.: 11/892,196

(22) Filed: Aug. 21, 2007

(30) Foreign Application Priority Data
Feb. 1, 2007 (TW) 096103771

(51) Int. Cl. H04R 1/02

(52) U.S. Cl. 381/388

(57) ABSTRACT

The loudspeaker system of the invention comprises at least one enclosure, at least one fastener, a sound amplifier unit, at least one speaker unit, at least one power supply unit, and an audio signal connector. The enclosure comprises a bottom face which is contoured to fit the shoulder strap of a backpack. Each of the fasteners is connected to each of the enclosures. The fasteners are used for fastening the enclosures on the shoulder straps. The sound amplifier unit is electrically connected to the speaker units, the power supply unit and the audio signal connector. The sound amplifier unit is contained in one of the enclosures. Each of the speaker units is contained in each of the enclosures. The at least one power supply unit is contained in the at least one enclosures. The audio signal connector can be electrically connected to an external audio rendering device.

### BACKGROUND OF THE INVENTION

1. Field of the Invention

The present invention relates to a loudspeaker system and, more particularly, the invention relates to a loudspeaker system which can be connected to the shoulder straps of a backpack.

2. Description of the Related Art

An audio rendering device, such as an MP3 player, is in common use. It uses an earplug-typed earphone or an ear-covered earphone to output the sound. This kind of earphone is connected to a user's ears directly. In the situation of using the audio rendering device in the outdoors, the user who wears an earphone can't hear the surrounding sounds clearly; therefore, the awareness of possible dangers in the environment is reduced. Take mountain climbing for example, a climber needs to hear to know what is happening around. By wearing earphones, the climber loses the vital sense of hearing the surroundings, such a warning or calling from friends. The earphone is not ideal for this type of activities at outdoors.

In order to reduce the potential danger of using earphones at outdoors, there is a device in the prior art which combines a loudspeaker device and a backpack in one unit. In one version the loudspeaker device is located in front of the backpack. In other words, when a user uses the backpack, the sound output of the speakers is directed toward the area behind the user. The device usually has high-power speakers and requires large and heavy batteries. This not only increases the weight of the backpack, but also annoys the others, especially those behind the user. Moreover, for the backpack integrates with the loudspeaker device, the speakers can not be removed and be mounted onto another backpack. This is not ideal for people who want to use their favorite backpacks.

The issue is also addressed in U.S. Pat. No. 5,409,152 “BACKPACK ASSEMBLY WITH AUDIO COMPONENTS”, published on Apr. 25, 1995, and U.S. Pat. No. 6,712,249 “BACKPACK ENTERTAINMENT SYSTEM WITH DETACHABLE POCKETS FOR SPEAKERS”, published on Mar. 30, 2004. However, in these patents backpack and speakers are also purpose-built for use with each other and are thus not interchangeable with other equipment. Furthermore, the output direction of the speakers is not toward the user's ears but toward the left and right sides of the user, requiring higher power output and wasting electric power.

Moreover, there are loudspeakers disclosed in the prior art which can be tied with the user directly. For instance, in U.S. Pat. No. 4,764,962 “STEREO SPEAKER SYSTEM FOR WALKMAN-TYPE RADIO AND/OR CASSETTE PLAYER”, published on Aug. 16, 1988, the loudspeaker device is mounted onto a user's shoulders and chest with many straps. Because the system requires the adjustment of many straps and fasteners, it is complicated. The structure doesn't fit the demand for backpack users, as there are too many straps to deal with under his backpack.

Therefore, it is desirable to provide a loudspeaker system which can be connected to the shoulder strap of a backpack in order to mitigate and/or obviate the aforementioned problems.

### SUMMARY OF THE INVENTION

The objective of the present invention is to provide a loudspeaker system whereby the speakers can be connected to the shoulder straps of a backpack.

In order to achieve the above-mentioned objective, the loudspeaker system of the invention can be electrically connected to an external audio rendering device, and the loudspeaker system can be connected to at least one shoulder strap of a backpack. The loudspeaker system comprises one or two enclosures, one or two fasteners, a sound amplifier unit, one or two speaker units, one or two power supply units and an audio signal connector. The enclosure comprises a bottom face which is contoured to fit the shoulder strap of a backpack. Each of the fasteners is connected to each of the enclosures. The fasteners are used for fastening the enclosure on the shoulder strap. The sound amplifier unit is contained in one of the enclosures. The speaker units are electrically connected to the sound amplifier unit. Each of the speaker units is contained in each of the enclosures.

Each of the power supply units is electrically connected to the sound amplifier unit. The at least one power supply unit is contained in at least one of the enclosures. The audio signal connector is electrically connected to the sound amplifier unit and can be connected to an external audio rendering device.

According to one of the embodiments of the invention, the fastener is a fastening strap, the output direction of the speaker units is toward a user's ears, and the bottom face of the enclosure is arc-shaped.

Other objects, advantages, and novel features of the invention will become more apparent from the following detailed description in conjunction with the accompanying drawings.

### BRIEF DESCRIPTION OF THE DRAWINGS

FIG. 1 is a framework diagram of the loudspeaker system of the invention.

FIG. 2 is a schematic diagram of the embodiment of the loudspeaker system of the invention.

FIG. 3 is a schematic diagram of the loudspeaker system of the invention in real practice.

### DETAILED DESCRIPTION OF THE PREFERRED EMBODIMENT

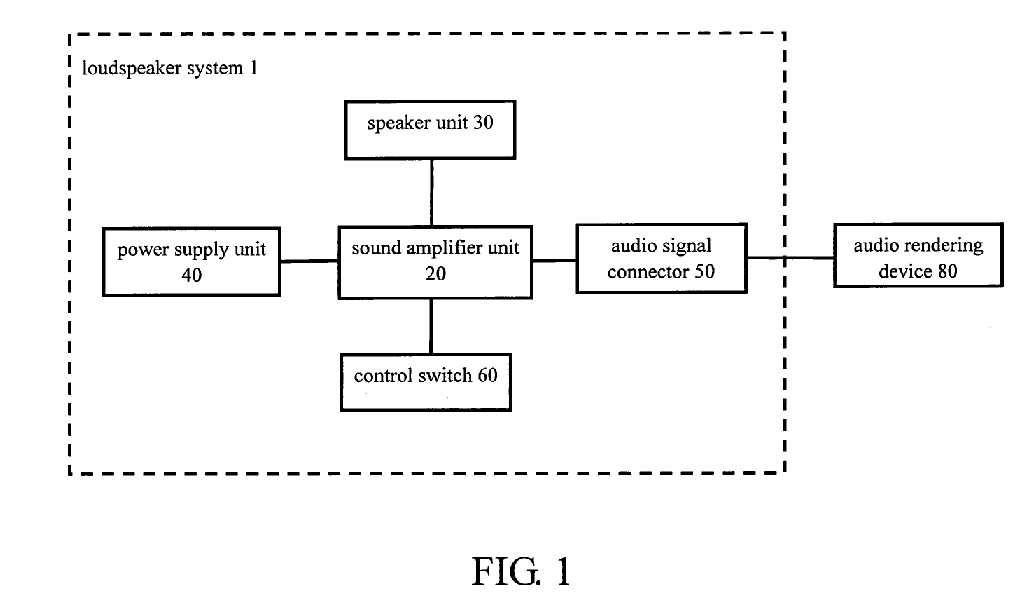

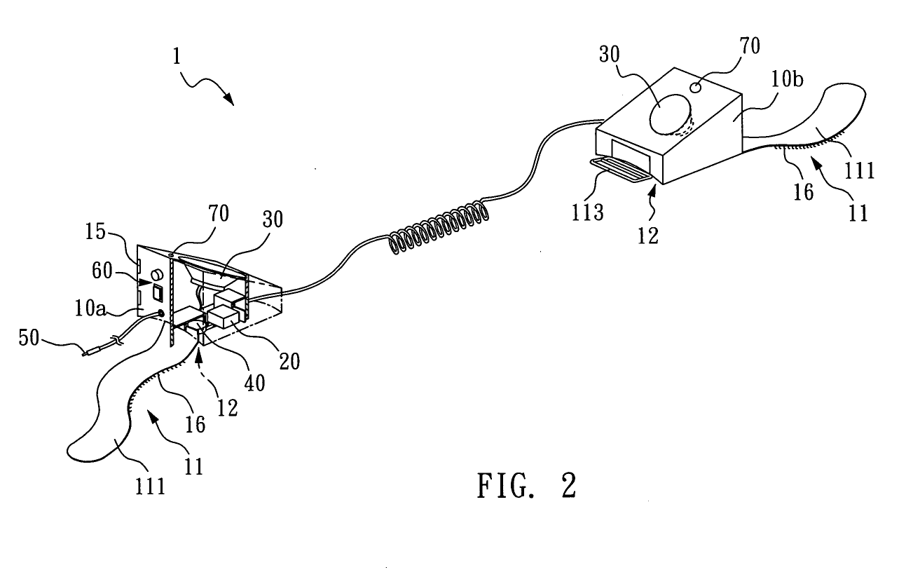

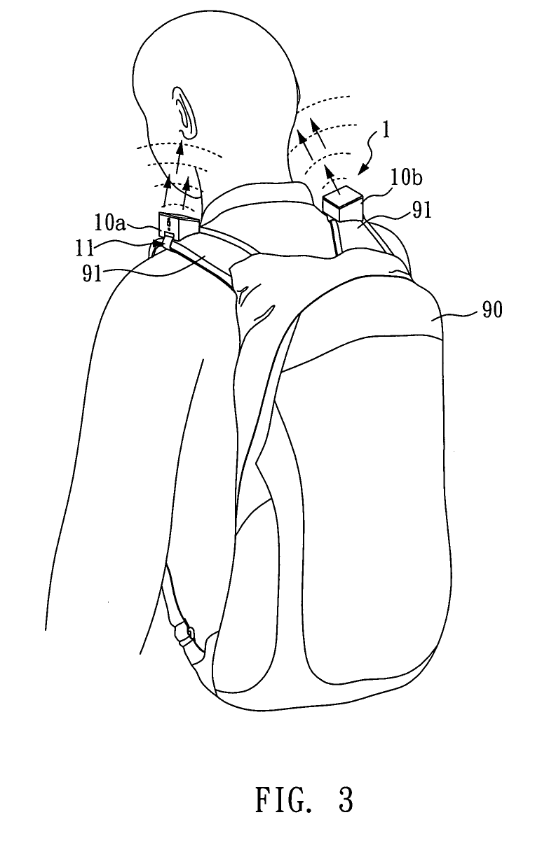

Please refer to FIG. 1 to FIG. 3 to illustrate the embodiment of the invention. FIG. 1 is a framework diagram of the loudspeaker system of the invention. FIG. 2 is a schematic diagram of the embodiment of the loudspeaker system of the invention. FIG. 3 is a schematic diagram of the loudspeaker system of the invention in real practice.

The loudspeaker system 1 of the invention can be electrically connected to an external audio rendering device 80. For example, the audio rendering device 80 can be an MP3 player, an MD player, an i-Pod, a CD player etc. The loudspeaker system 1 can be connected to one or two straps. In the embodiment of the invention, the loudspeaker system 1 is connected to two straps 91 of the backpack 90 (Please refer to FIG. 3). The loudspeaker system 1 comprises at least one enclosure 10a-10b, at least one fastener 11, a sound amplifier unit 20, at least one speaker unit 30, at least one power supply unit 40, a audio signal connector 50, and a controller 60.

Please refer to FIG. 1. The sound amplifier unit 20 is electrically connected to the speaker unit 30, the power supply unit 40, the audio signal connector 50, and the controller 60. Through the audio signal connector 50, the audio rendering device 80 transmits the audio signal to the sound amplifier unit 20. The audio signal amplified by the sound amplifier unit 20 outputs to the speaker unit 30. The controller 60 is used for controlling various functions for the output of the speaker unit 30. The electric power which the loudspeaker system 1 needs is provided by the power supply unit 40.

Please refer to FIG. 2. In order to obtain stereophonic sound, two speaker units are required. Therefore, the embodiment of the loudspeaker system 1 comprises two enclosures 10a-10b. The enclosures 10a-10b comprise a bottom face which is contoured to fit) the shoulder straps 91. Because the shoulder of the user is arc-shaped, the bottom face 12 is designed accordingly, thus making the bottom face 12 fits closely to the shoulder strap 91. It is important to note that the appearance of the enclosures 10a-10b is not limited to the one shown in FIG. 2. The enclosures 10a-10b can be designed in different styles according to demand.

The purpose of the fastener 11 is to fasten the enclosures 10a-10b on the shoulder straps 91 of a backpack 90. The quantity of the fasteners 11 matches the quantity of the enclosures 10a-10b, and each of the fasteners 11 is connected to each of the enclosures 10a-10b. In this embodiment, each of the two fasteners 11 is connected individually to each of the two enclosures 10a-10b. In this embodiment, the fastener is a fastening strap, and each of the fasteners 11 comprises a belt 111 and a buckle 113. The belt 111 passes through the buckle 113 to achieve fastening. The loudspeaker system 1 can be fastened to the shoulder strap 91 or be removed from the shoulder strap 91 easily.

The belt 111 comprises a skid-proof unit 16. The skid-proof unit 16 is a small piece of the hook side of a Velcro (Shown in FIG. 2). The under-side of a shoulder strap 91 is in direct contact with this Velcro's hook side to greatly increase the friction between the belt 111 and the shoulder strap 91, preventing the loudspeaker system from slipping down the shoulder strap 91. It is important to note that the skid-proof unit 16 can be of other material or structure then described here.

It is also important to take note that the fastener 11 can be another element with fastening function instead of the one described. For example, the fastener 11 can be a clip which links the belt 111 and the shoulder strap 91, or only Velcro strap can be used to connect the belt 111 to the shoulder strap 91.

The loudspeaker system usually comprises a suitable sound amplifier unit 20, contained in one of the enclosures 10a-10b, to drive the speakers with ample power. In this embodiment, the sound amplifier unit 20 is contained in the enclosure 10a. The sound amplifier unit 20 can be an amplifying or a magnifying circuit with audio amplification function.

The audio signal which is amplified by the sound amplifier unit 20 outputs to the at least one speaker unit 30. The speaker unit 30 is electrically connected to the sound amplifier unit 20. The quantity of the speaker units 30 matches the quantity of the enclosures 10a-10b, and each of the speaker units 30 is connected to each of the enclosures 10a-10b. In this embodiment, each of the two speaker units 30 is connected individually to each of the two enclosures 10a-10b. It is important to note that the speaker unit 30 does not need to be implemented as a single speaker (Refer to FIG. 2), but also as several speakers. In the latter case, the speakers of one speaker unit will provide output in different frequency ranges, e.g. output either high-pitch or low-pitch sound.

Furthermore, the efficiency of the loudspeaker system 1 is increased and the unnecessary spreading of sound to the surrounding area is minimized by directing the speaker unit 30 toward the user's ears (Refer to arrow direction shown in FIG. 3). It is important to note that the speaker unit 30 can also be designed so the output direction can be adjusted to suit various users' demands.

Each of the power supply unit 40 is electrically connected to the sound amplifier unit 20. The loudspeaker system comprises at least one suitable power supply unit, contained in at least one of the enclosures 10a-10b. In this embodiment, one power supply unit 40 is contained in the enclosure 10a. In this embodiment, the power supply unit 40 is a battery, and the battery can be an ordinary battery (e.g., dry cell) or a rechargeable battery. In addition, the loudspeaker system 1 can also comprise a mini-USB socket for external electric power supply.

The audio signal connector 50 is electrically connected to the sound amplifier unit 20 and the external audio rendering device 80. In this embodiment, the audio signal connector 50 is an audio plug for an MP3 player or an MD player etc. with diameter of 3.5 mm. The audio plug enables a quick connection of the loudspeaker system 1 to the audio rendering device 80. The audio signal connector 50 can also be a socket with diameter of 3.5 mm for audio signal input.

Switching on/off the loudspeaker system 1 and adjusting the sound volume are achieved by one or more control switches 60, which are electrically connected to the sound amplifier unit 20.

Then please refer to FIG. 3. The two enclosures 10a, 10b are individually connected to the two shoulder straps 91 of the backpack, and the two shoulder straps 91 are located on the left and right shoulder of the user. The output direction of the loudspeaker units 30 is toward the user's ears (Refer to the arrows in the FIG.) in order to achieve a clear perception of the sound and to minimize the sound spreading to annoy the others. The loudspeaker system 1 of the invention has the advantages of easy carrying, connecting and disconnecting, applicable to most portable sound rendering devices, and applicable to all backpacks. Furthermore, the enclosures 10a, 10b comprise mating connectors 15 in order to provide a different way of usage besides connecting the loudspeaker system 1 to a backpack. The connectors 15 are used for interlocking the two enclosures 10a, 10b together in order to be placed on a surface (for example on a desk). The connectors 15 may be latches mating with each other.

Moreover, the loudspeaker system 1 comprises a warning device 70 which is electrically connected to the power supply unit 40. The warning device 70 is used to increase the user's safety while roaming outdoors when dark. For example, the warning device 70 is a high brightness LED with flashing ability.

Although the present invention has been explained in relation to its preferred embodiment, it is to be understood that many other possible modifications and variations can be made without departing from the spirit and scope of the invention as hereinafter claimed.

What is claimed is:

1. A loudspeaker system which can be electrically connected to an audio rendering device and can be connected to at least one shoulder strap of a backpack comprising:
at least one enclosure; each of the at least one enclosure comprises a bottom face which is contoured to fit the shoulder strap of the backpack;
at least one fastener; each of the at least one fastener is connected to each of the at least one enclosure for fastening the enclosure onto the shoulder strap;
a sound amplifier unit which is contained in one of the at least one enclosure;
at least one speaker unit which is electrically connected to the sound amplifier unit; each of the at least one speaker unit is contained in each of the at least one enclosure;
at least one power supply unit which is electrically connected to the sound amplifier unit; the at least one power supply unit is contained in the at least one enclosure; and
an audio signal connector which is electrically connected to the sound amplifier unit and the audio rendering device.

2. The loudspeaker system as claimed in claim 1, wherein the fastener is a fastening strap.

3. The loudspeaker system as claimed in claim 2, wherein the bottom face is arc-shaped.

4. The loudspeaker system as claimed in claim 3, wherein the output direction of the at least one speaker unit is toward a user's ear.

5. The loudspeaker system as claimed in claim 1, wherein the output direction of the at least one speaker unit is toward a user's ear.

6. The loudspeaker system as claimed in claim 1, wherein the bottom face is arc-shaped.

7. The loudspeaker system as claimed in claim 1, wherein the audio signal connector is an audio plug with diameter of 3.5 mm or an audio socket with diameter of 3.5 mm.

8. The loudspeaker system as claimed in claim 1, wherein the loudspeaker system further comprises a mini-USB socket.

9. The loudspeaker system as claimed in claim 1, wherein the fastener further comprises a skid-proof unit.

10. The loudspeaker system as claimed in claim 1, wherein each one of the enclosures further comprises a connector for connecting each of the at least one enclosure.

11. The loudspeaker system as claimed in claim 1, wherein each of the at least one power supply unit is a battery.

12. The loudspeaker system as claimed in claim 1, wherein the loudspeaker system comprises at least one control switch which is electrically connected to the sound amplifier unit for controlling the sound amplifier unit.

13. The loudspeaker system as claimed in claim 1, wherein the audio rendering device is an MP3 player.

14. The loudspeaker system as claimed in claim 1, wherein the loudspeaker system further comprises a warning device.
